(19) United States
(12) Patent Application Publication
(10) Pub. No.: US 2017/0052708 A1
(43) Pub. Date: Feb. 23, 2017

(54) METHOD FOR ACCESSING FLASH MEMORY AND ASSOCIATED MEMORY CONTROLLER AND ELECTRONIC DEVICE

(71) Applicant: MStar Semiconductor, Inc., Hsinchu Hsien (TW)

(72) Inventors: Chien-Hsiang Li, Hsinchu County (TW); Wen-Hao Sung, Hsinchu County (TW); Tse-Wei Wang, Hsinchu County (TW)

(21) Appl. No.: 15/133,639

(22) Filed: Apr. 20, 2016

(30) Foreign Application Priority Data
Aug. 21, 2015 (TW) 104127351

(51) Int. Cl. G06F 3/06; G06F 12/10

(52) U.S. Cl. CPC G06F 3/0605; G06F 3/061; G06F 3/0616; G06F 3/064; G06F 3/0644; G06F 3/0659; G06F 3/0679; G06F 12/1009; G06F 2212/1016; G06F 2212/1036; G06F 2212/214; G06F 2212/7201

(57) ABSTRACT

A method for accessing a flash memory includes: sending a write command and a set of corresponding data, wherein the data is for updating a part of contents of a first physical page, corresponding to a logical page, of a physical block in a flash memory; searching the physical block according to the write command for a second physical page that is allowed to be written; writing the data to the second physical page; and recording that the second physical page corresponds to the logical page.

This application claims the benefit of Taiwan application Serial No. 104127351, filed Aug. 21, 2015, the subject matter of which is incorporated herein by reference.

### BACKGROUND OF THE INVENTION

Field of the Invention

The invention relates in general to a flash memory, and more particularly to a method for accessing a flash memory and associated memory controller and electronic device.

Description of the Related Art

A current electronic device usually includes a flash memory for storing required data. Taking a current smart television for example, a flash memory therein records operation records of a user, e.g., information of a previous channel selection operation, or records associated with applications. Thus, a flash memory undergoes frequent write and erase operations.

One flash memory includes multiple blocks, each of which including multiple pages. One “block” is a smallest erase unit. As such, when only a part of data in one block needs to be updated, a memory controller is incapable of directly updating contents of that part. Instead, contents of the block is read and are jointly written with data to be updated to a new empty block, and original contents of the block are erased. As described, since a update process of data in a flash memory requires more complicated steps, the performance of the flash memory may be severely degraded if data is updated frequently.

Further, data generated from a consumer operating an electronic device is random, and so new data is written to a page in a block before the page is completely filled, making the above operation of data moving and block erasing inevitable. Thus, while the speed of data writing is slowed down due to the erase operation, the behavior of constantly erasing a block before the block is filled by data further shortens an already limited lifecycle of a flash memory. The so-called lifecycle of a flash memory refers to the limited number of times for erasing and writing data to each block. Repeatedly erasing and writing to a same block may slow down the access speed to even damage the flash memory or lead to a total malfunction of the flash memory. To prevent the above issues, wear leveling technologies are available. In wear leveling technologies, it is aimed to use each of the blocks in a flash memory evenly, so as to prevent any specific block from excessive use that may cause permanent damage and an inoperable electronic device. However, an inadequate software management method that involves excessively frequent erasing and write operations may nonetheless lead to a shortened lifecycle of a flash memory.

### SUMMARY OF THE INVENTION

The invention is directed to a method for accessing a flash memory. The method is capable of significantly reducing the number of times of erase operations of the flash memory to enhance application performance and to prolong the lifecycle of the flash memory.

According to an aspect of the present invention, a method for accessing a flash memory includes: sending a write command and a set of corresponding data, wherein the data is for updating a part of contents of a first physical page, corresponding to a logical page, of a physical block in the flash memory; searching the physical block according to the write command for a second physical page that is allowed to be written; writing the data to the second physical page; and recording that the second physical page corresponds to the logical page.

According to another embodiment of the present invention, an electronic device includes a processor, a flash memory and a memory controller. The memory controller, coupled between the processor and the flash memory, controls access of the flash memory. The processor sends a write command and a set of corresponding data, wherein the data is for updating a part of contents of a first physical page, corresponding to a logical page, of a physical block in the flash memory. The memory controller searches the physical block according to the write command for a second physical page that is allowed to be written, writes the data to the second physical page, and records that the second physical page corresponds to the logical page.

According to another embodiment of the present invention, a memory controller is disclosed. The memory controller receives a write command and a set of corresponding data. The data is for updating a part of contents of a first physical page, corresponding to a logical page, of a physical block in a flash memory. The memory controller further searches the physical block according to the write command for a second physical page that is allowed to be written, writes the data to the second physical page, and records that the second physical page corresponds to the logical page.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of an electronic device according to an embodiment of the present invention;

FIG. 2A is a schematic diagram of an example of a physical block in a flash memory;

FIG. 2B is a schematic diagram of a logical-physical page mapping table;

FIG. 3 is a flowchart of establishing a logical-physical page mapping table according to an embodiment of the present invention;

FIG. 4 is a flowchart of a method for accessing a flash memory according to an embodiment of the present invention;

FIG. 5 is a schematic diagram of a physical block and a corresponding logical-physical page mapping table after the process in FIG. 4;

FIG. 6 is a flowchart of reading a physical page according to an embodiment of the present invention; and

FIG. 7 is a schematic diagram of a physical block and a corresponding logical-physical page mapping table according to an embodiment of the present invention.

### DETAILED DESCRIPTION OF THE INVENTION

Throughout the specification and the appended claims, certain terms are utilized for referring to specific elements. A person having ordinary skill in the art can easily appreciate that, different terms may be used by hardware manufacturers to refer to a same element. Differences in those terms in the specification and the appended claims are not to be construed for distinguishing the elements, and the elements are in fact differentiated based on functional differences. Throughout specification and the appended claims, the term “comprise” is regarded as an open-end term to be explained as “include but not limited to”. Further, the term “couple” includes any means of direct and indirect electrical connections. Therefore, if it is described that a first device is coupled to a second device, it means that the first device may be electrically connected to the second device in a direct manner, or in an indirectly manner through other devices and connection means.

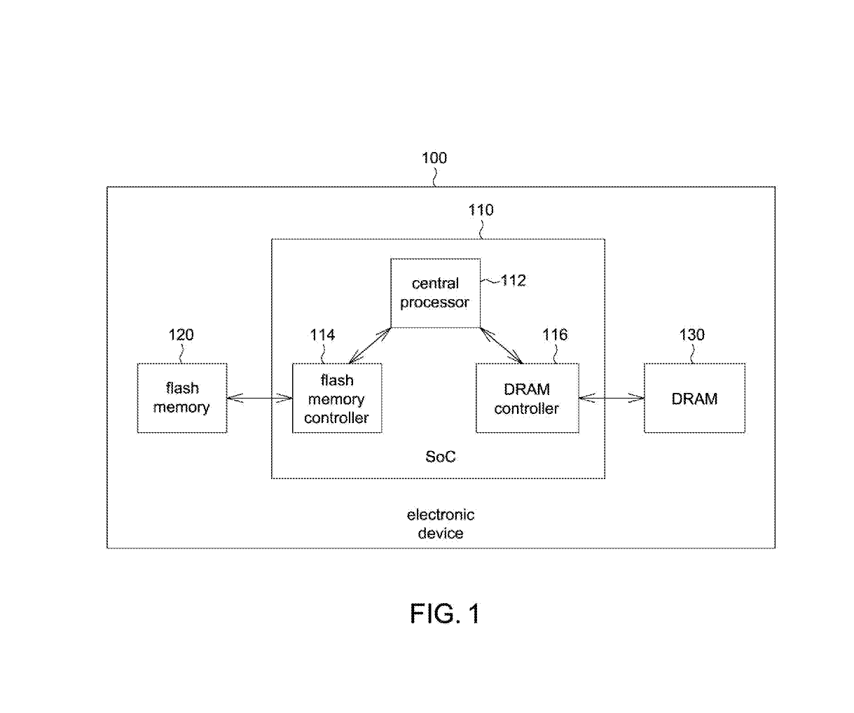

FIG. 1 shows a schematic diagram of an electronic device 100 according to an embodiment of the present invention. As shown in FIG. 1, the electronic device 100 includes a system-on-chip (SoC) 110, a flash memory 120 and a dynamic random access memory (DRAM) 130. The SoC 110 includes a central processor 112, a flash memory controller 114 and a DRAM controller 116. The flash memory controller 114 controls access of the flash memory 120, and the DRAM controller 116 controls access of the DRAM 130. In the embodiment, for example but not limited to, the electronic device 100 is a television or a set-top box (STB). In other embodiments, the electronic device 100 may be any electronic device that includes a flash memory, e.g., a digital camcorder, a mobile communication device, a desktop computer, a laptop computer, or an external storage device.

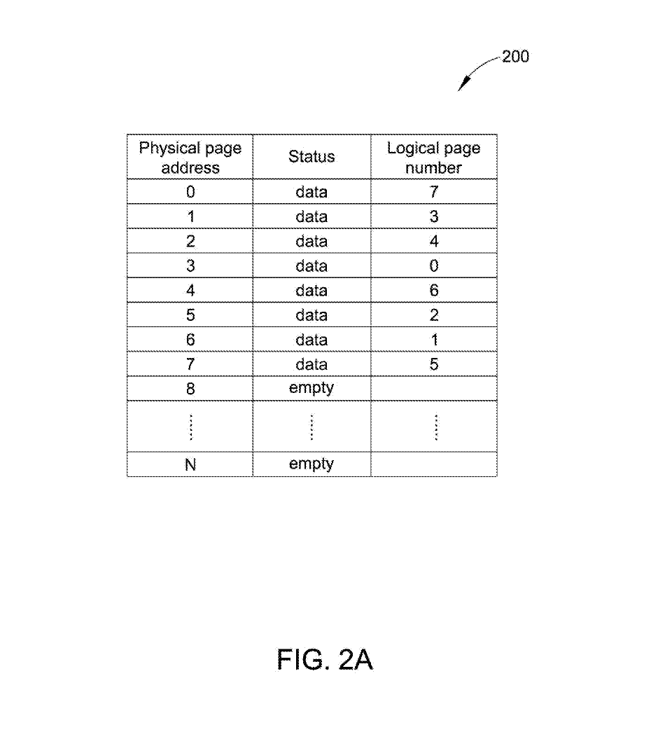

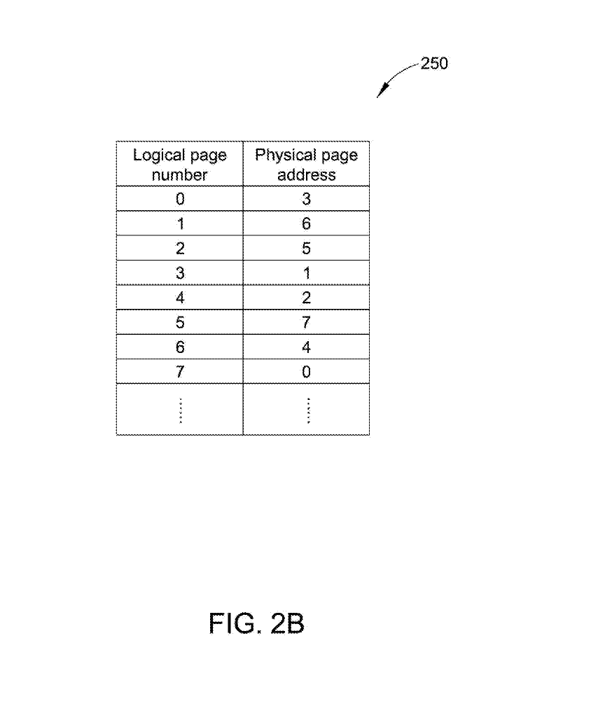

The flash memory 120 may include one or multiple flash memory chips. Each flash memory chip includes multiple physical blocks, each of which including multiple physical pages. Each physical page of each physical block has a corresponding physical page address. In other words, each physical page address corresponds to a predetermined physical page of a predetermined physical block. FIG. 2A shows a schematic diagram of a physical block 200 in the flash memory 120. In the description and drawings below, the term “number” is used to describe a “physical page address”, which is an address in the flash memory 120 and is not repeated. Therefore, the method of describing the “physical page address” using numbers is for illustrative purposes, and these numbers do not represent real contents of the physical page address. As shown in FIG. 2A, in the physical block 200, only 8 physical pages numbered 0 to 7 store data, whereas the remaining physical pages numbered 8 to N do not store data. Further, in the physical block 200, the logical page numbers respectively corresponding to the physical pages are also recorded. For example, the physical page address 0 corresponds to the logic page number 7, the physical page address 1 corresponds to the logical page number 3, the physical page address 2 corresponds to the logical page number 4 . . . etc. These corresponding page numbers may be recorded in a spare/remaining area of each physical page, or any other suitable place. It should be noted that, the numbers of the physical page addresses are for illustrative purposes, and each number in fact represents one physical page address corresponding to one physical page.

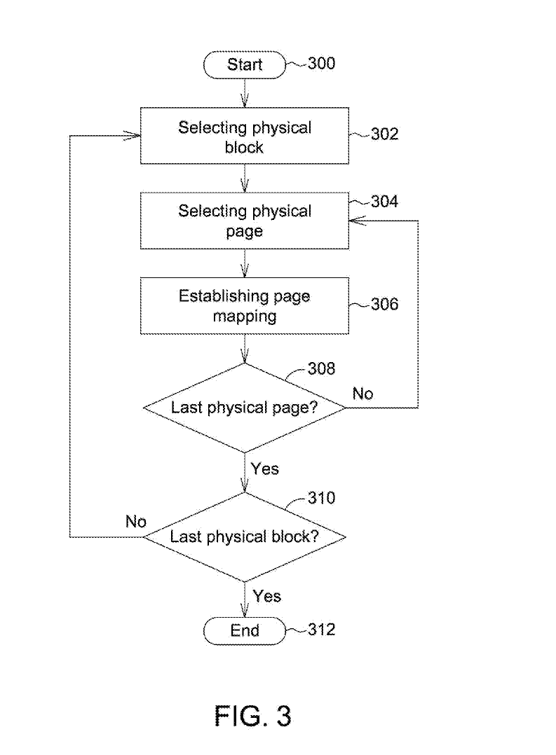

When the electronic device 100 is booted, the central processor 112 reads the contents of each physical block of the flash memory 120 (or the central processor 112 accesses the contents of each physical block of the flash memory 120 via the flash memory controller 114) to establish a logical-physical page mapping table, and stores the logical-physical page mapping table in a memory. FIG. 2B shows a schematic diagram of a logical-physical page mapping table 250. For simplicity, the logical-physical page mapping table 250 in FIG. 2B depicts only a part of contents of the block 200 in FIG. 2A. In the embodiment, for example, the physical-logical page mapping table 250 is stored in the DRAM 130 via the DRAM controller 116. In other embodiments, the logical-physical page mapping table may be stored in the SoC 110 or a memory unit in the flash memory 114. FIG. 3 shows a flowchart of establishing a logical-physical page mapping table according to an embodiment of the present invention. More specifically, referring to FIG. 3, in step 300, the process begins. In step S302, a first physical block is selected. In step 304, a first physical page of the first physical block is selected. In step 306, a mapping relationship (e.g., the logical-physical page mapping table 250 in FIG. 2B) between the selected physical page and the corresponding logical page is established. In step 308, it is determined whether the current physical page is the last physical page. Step 310 is performed if so, or else the process returns to step 304 to select a next physical page. In step 310, it is determined whether the current physical block is the last physical block. Step 312 is performed to end the process if so, or else the process returns to step 302 to select the next physical block.

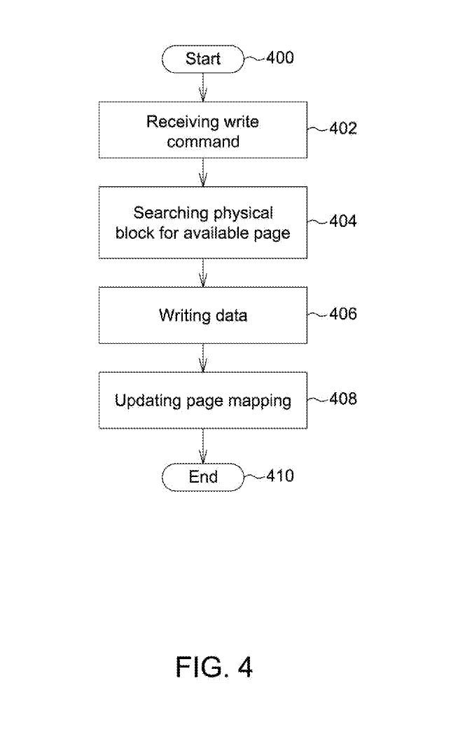

FIG. 4 shows a flowchart of a method for accessing a flash memory according to an embodiment of the present invention. In the embodiment, it is assumed that the central processor 112 needs to update a part of data in the flash memory 120. In step 400, the process begins. In step 402, the central processor 112 sends a write command and a set of corresponding data to the flash memory controller 114. The data is for updating at least a part of contents of a physical page of a physical block in the flash memory 120. In the embodiment, for illustrative purposes, it is assumed that the data is for updating at least a part of contents of the physical page numbered 2 in FIG. 2A in the description below. In step 404, the flash memory controller 114 searches the physical block 200 according to the write command for a physical page that is allowed to be written, i.e., searching for an available empty page. In the embodiment, as the data of the flash memory needs to be sequentially written according to an order of the pages, the physical page numbered 8 in the physical block 200 is found. In step 406, the flash memory controller 114 writes the data to the physical page numbered 8. In this step, if the data of the central processor 112 is for updating only a part of contents of the page at the physical page address 2, the flash memory controller 114 is required to read contents that need not be updated from the physical page address 2, and jointly writes the contents that need not be updated and the data to the page at the physical page address 8. In step 408, the central processor 112 updates the logical-physical page mapping table (or the central processor 112 updates the logical-physical page mapping table via the flash memory controller 114) to update that the logical page number 4 corresponds to the physical page address 8.

Further, in step 404 in FIG. 4, if each of the physical pages of the physical block 200 already stores data and no available physical page is found, the flash memory controller 114 moves the data and at least a part of the data in the physical block 200 to another physical page, and erases the physical block 200. Further, it should be noted that, the operation of “erasing the physical block 200” does not necessarily mean immediately and completely deleting the data from the physical data block 200. Instead, the physical block 200 may be first marked as a deleted status, and the data contents in the physical block 200 is cleared during an idle period of the flash memory controller 114 or removed only when there is data to be written to the physical block 200.

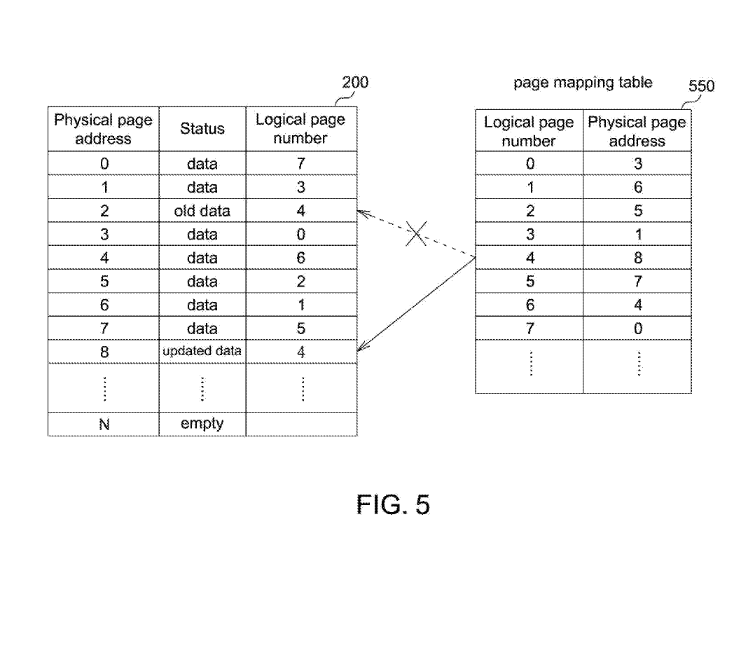

FIG. 5 shows a schematic diagram of the physical block 200 and a logical-physical page mapping table 550 after the process in FIG. 4.

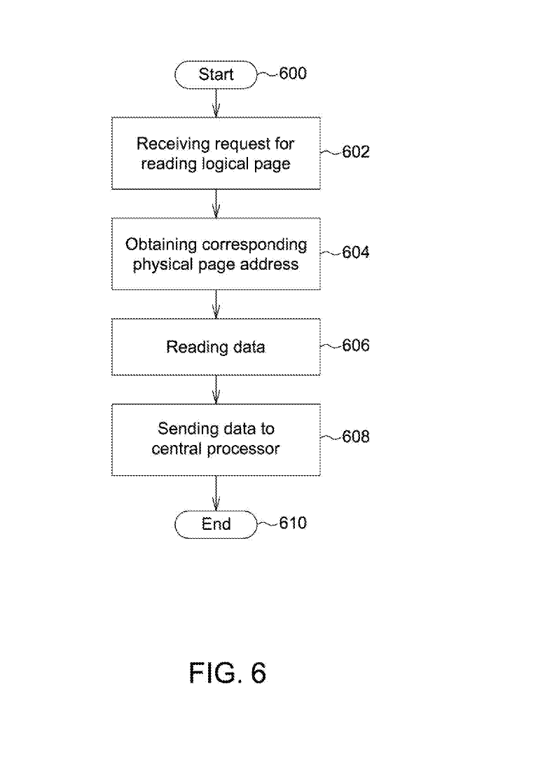

FIG. 6 shows a flowchart of a method for reading a physical page according to an embodiment of the present invention. In the embodiment, it is assumed that the central processor 112 needs to read data in the logical page number 4 in FIG. 5. In step 600, the process begins. In step 602, the central processor 112 sends a read request to the flash memory controller 114 to request reading data. In step 604, the flash memory controller 114 obtains the corresponding physical page address according to the read request and the logical-physical page mapping table. In this embodiment, for example, the flash memory controller 114 obtains the physical page address 8, and then reads the data on the physical page at the physical page address 8 in the flash memory 120. In step 608, the flash memory controller 114 sends the read data to the central processor 112. The process then enters step 610 to end the read operation. It should be noted that, as previously described, each physical number in fact represents a physical page address corresponding to a physical page.

Further, taking the example in FIG. 5 for instance, when the electronic device 100 needs to be re-booted and a logical-physical page mapping table needs to re-established, the central processor 112 sequentially reads each of the physical pages of the physical block 200 and the recorded corresponding logical page numbers via the flash memory controller 114, e.g., reading the spare/remaining area of each of the physical pages, to establish the logical-physical page mapping table. However, the physical page addresses 2 and 8 both correspond to the logical page number 4. Thus, in the embodiment, as the page at the physical page address 2 stores old data, the logical-physical page mapping table only records that the logical page number 4 corresponds to the physical page address 8. FIG. 5 shows the newly established logical-physical page mapping table 550. Comparing the logical-physical page mapping table 550 with the logical-physical page mapping table 250 in FIG. 2B, it is discovered that the logical page number 4 has switched to correspond the physical page address 8. In other words, during the process of establishing a logical-physical page mapping table, if it is found that multiple physical page addresses all correspond to the same logical page number, because the data is more updated as the physical page address gets larger, the central processor 112 maps the logical page number to the physical page address having a largest value in the multiple physical page addresses via the flash memory controller 114. It should be noted that, the foregoing numbers of the physical page address are for illustrative purposes only, and the value of each number is in fact associated with the corresponding physical page address. For example but not limited to, in this embodiment, a physical page address is closer to the back as the number gets larger.

As previously described, in the embodiments of the present invention, when data in a physical block needs to be updated, the flash memory controller 114 may directly store data of an updated page to an available page of the same physical block. Thus, the number of times of moving block data and erasing blocks can be significantly reduced to further enhance application performance and to prolong the lifecycle of the flash memory.

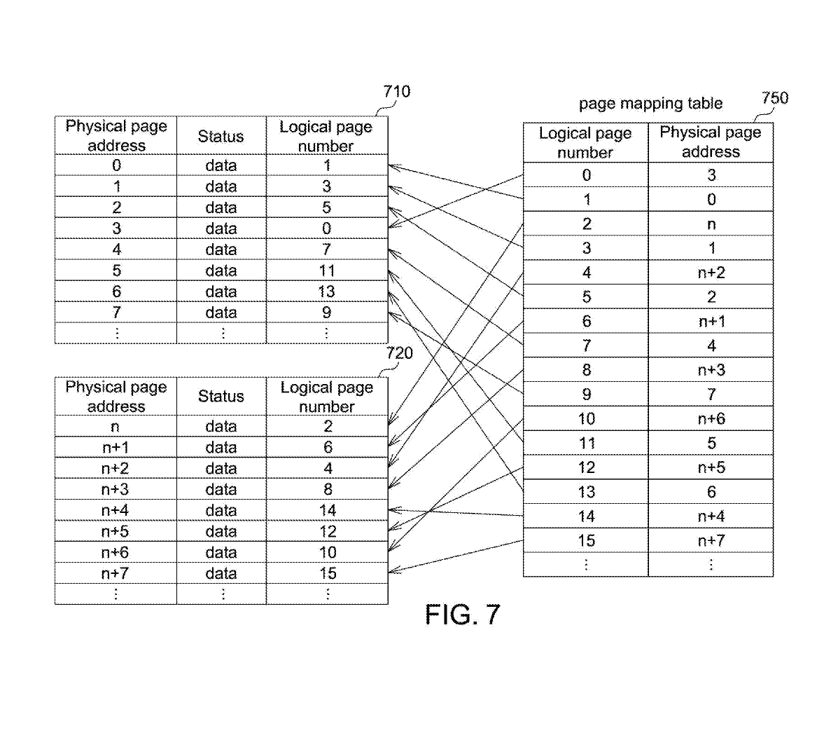

Further, in the above embodiments, for one physical block, the correspondence between multiple physical page addresses of the physical block and logical page numbers is recorded in a logical-physical page mapping table. To further reduce the number of times of moving block data and erasing blocks, one logical-physical page mapping table may also record the correspondence between multiple physical page addresses of two physical blocks (not limited to two) and logical page numbers, so as to provide more physical pages for enhanced flexibility during processes of storing and updating data. For example, referring to FIG. 7, the correspondence between physical pages of two physical blocks 710 and 720 and logical pages is recorded in the same logical-physical page mapping table. In the description and drawings below, the term “number” is used to describe a “physical page address”, which is an address in the flash memory and is not repeated. Therefore, the method of describing the “physical page address” using numbers is for illustrative purposes, and these numbers do not represent real contents of the physical page address. In the example in FIG. 7, when physical pages in the physical blocks 710 and 720 need to be updated, corresponding operations are identical to those described in the embodiments in FIGS. 4 and 5. That is, when the page at the physical page address 1 in the physical block 710 needs to be updated, the flash memory controller 114 stores the updated data to the physical page at the physical page address 8 in the physical block 710, and records the corresponding logical page number 3. When the physical page at the physical page address (n+5) in the physical block 720 needs to be updated, the flash memory controller 114 stores the updated data to the physical page at the physical page address (n+8) (assuming that the physical page at the physical page address (n+8) is an empty page) in the physical block 720, and records the corresponding logical page number 12. Alternatively, for example, when the physical page at the physical page address 6 in the physical block 710 needs to be updated and the physical block contains no empty physical pages, the flash memory 114 may store the updated data to the empty physical page in the physical block 720, and records the corresponding logical page number 13.

In conclusion, in the method for accessing a flash memory and the associated memory controller and electronic device of the present invention, when data in the physical block needs to be updated, the flash memory controller directly stores the updated page data to an available page of the same physical block. Therefore, the number of times of moving block data and erasing blocks can be significantly reduced to further enhance application performance and to prolong the lifecycle of the flash memory.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for accessing a flash memory, comprising:
sending a write command and a set of corresponding data, wherein the data is for updating a part of contents of a first physical page, corresponding to a logical page, of a physical block in a flash memory;
searching the physical block according to the write command for a second physical page that is allowed to be written;
writing the data to the second physical page; and
recording that the second page corresponds to the logical page.

2. The method according to claim 1, wherein the step of searching the physical block according to the write command for the second physical page that is allowed to be written comprises:
searching the physical block for an empty physical page having a smallest physical page address to serve as the second physical page.

3. The method according to claim 1, wherein the step of writing the data to the second physical page comprises:
reading contents that do not need to be updated in the first physical page, and jointly writing the read contents and the data to the second physical page.

4. The method according to claim 1, further comprising:
when the physical block does not comprise the physical page that is allowed to be written, writing the data and at least a part of data read from the physical block to another physical page, and erasing contents of the physical block.

5. The method according to claim 1, further comprising:
updating a logical-physical page mapping table to indicate that the logical page corresponds to the second physical page, the logical-physical page mapping table recording correspondence between different logical pages and different physical pages.

6. The method according to claim 5, further comprising:
sending another write command and another set of corresponding data, the another set of data is for updating a part of contents of a third physical page, corresponding to another logical page, of another physical block in the flash memory;
searching the another physical block according to the another write command for a fourth physical page that is allowed to be written;
writing the another set of data to the fourth physical page;
recording that the fourth physical page corresponds to the another logical page; and
updating the logical-physical page mapping table to indicate that the another logical page corresponds to the fourth physical page.

7. The method according to claim 1, further comprising:
when the physical block does not comprise the physical page that is allowed to be written, searching another physical block according to the write command for a third physical page that is allowed to be written, writing the data to the third physical page, and recording that the third physical page corresponds to the logical page.

8. The method according to claim 1, wherein the physical block comprises a spare area, the step of recording that the second physical page corresponds to the logical page is recording to the spare area, the method further comprising:
reading each physical page of the physical block and the logical page corresponding to each physical block as recorded in the spare area; and
establishing a logical-physical page mapping table according to a read result, the logical-physical page mapping table recording correspondence between different logical pages and different physical pages;
wherein, when the read result indicates that there are multiple physical pages corresponding to the same logical page, the logical-physical page mapping table records that the logical page corresponds to the physical page having a largest physical page address among the physical pages.

9. An electronic device, configured to access a flash memory, comprising:
a processor, sending a write command and a set of corresponding data, wherein the data is for updating a part of contents of a first physical page, corresponding to a logical page, of a physical block in the flash memory; and
a memory controller, coupled between the processor and the flash memory, searching the physical block according to the write command for a second physical page that is allowed to be written, writing the data to the second physical page, and recording that the second physical page corresponds to the logical page.

10. The electronic device according to claim 9, wherein the second physical page is an empty physical page having a smallest physical page address in the physical block.

11. The electronic device according to claim 9, wherein the memory controller further reads contents that need not be updated in the first physical page, and jointly writes the read contents and the data to the physical page.

12. The electronic device according to claim 9, wherein when the physical block does not comprise the physical page that is allowed to be written, the memory controller writes the data and at least a part of data read from the physical block to another physical page, and erases contents of the physical block.

13. The electronic device according to claim 9, wherein the processor updates a logical-physical page mapping table, the logical-physical page mapping table recording correspondence between different logical pages and different physical pages, and updates that the logical page corresponds to the second physical page.

14. The electronic device according to claim 13, wherein the processor sends another write command and another set of corresponding data to the memory controller, the another set of corresponding data is for updating a part of contents of a third physical page, corresponding to another logical page, of another physical block in the flash memory; the memory controller searches the another physical block according to the another write command for a fourth physical page that is allowed to be written, writes the another set of data to the fourth physical page, and records that the fourth physical page corresponds to the another logical page; and the processor updates the logical-physical page mapping table to indicate that the another logical page corresponds to the fourth physical page.

15. The electronic device according to claim 9, further comprising:
when the physical block does not comprise the physical page that is allowed to be written, the memory controller searches the another physical block according to the write command for a third physical page that is allowed to be written, writes the data to the third physical page, and records that the third physical page corresponds to the logical page.

16. The electronic device according to claim 9, wherein physical block comprises a spare area; the memory controller further reads each physical page of the physical block and the logical page corresponding to each page as recorded in the spare area to generate a read result; the processor establishes a logical-physical page mapping table according to the read result, the logical-physical page mapping table recording correspondence between different logical pages and different physical pages; when the read result indicates that there are multiple physical pages corresponding to the same logical page, the logical-physical page mapping table records that the logical page corresponds to the physical page having a largest physical page address among the physical pages.

17. A memory controller, configured to receive a write command and a set of corresponding data, wherein the data is for updating a part of contents of a first physical page, corresponding to a logical page, of a physical block of a flash memory; the memory controller searching the physical block according to the write command for a second physical page that is allowed to be written, writing the data to the second physical page, and recording that the second physical page corresponds to the logical page.
